(19) United States
(12) Patent Application Publication
(10) Pub. No.: US 2013/0179085 A1
(43) Pub. Date: Jul. 11, 2013

(54) PRECISION PHENOTYPING USING SCORE SPACE PROXIMITY ANALYSIS

(71) Applicant: PIONEER HI-BRED INTERNATIONAL, INC., JOHNSTON, IA (US)

(72) Inventors: Jan Hazebroek, Johnston, IA (US); James Janni, Johnston, IA (US); Steven L. Wright, (US)

(73) Assignee: PIONEER HI-BRED INTERNATIONAL, INC., JOHNSTON, IA (US)

(21) Appl. No.: 13/647,623

(22) Filed: Oct. 9, 2012

Related U.S. Application Data
(60) Provisional application No. 61/546,672, filed on Oct. 13, 2011.

(51) Int. Cl. G06F 19/18

(52) U.S. Cl. CPC G06F 19/18
USPC 702/19

(57) ABSTRACT

Methods are provided for determining the level of perturbation of a phenotype in an organism using a multivariate statistical analysis. The method comprises a first step of collecting at least one measurement from at least one control group of organisms and at least one experimental group of organisms to produce a set of data. The method further comprises a second step of using a processor to conduct a multivariate statistical analysis on the set of data to determine the level of perturbation of a phenotype or trait of interest in the experimental group of organisms. Methods are further provided for selecting a group of organisms based on the multivariate statistical analysis.

### CROSS-REFERENCE TO RELATED APPLICATIONS

This Application claims the benefit of U.S. Provisional Application No. 61/546,672, filed Oct. 13, 2011, the content of which is herein incorporated by reference in its entirety.

### FIELD OF THE INVENTION

The invention relates to the field of plant biology and, more particularly, the use of statistical analyses to accurately determine changes in plant phenotypes.

### BACKGROUND

The agricultural industry continuously develops new plant varieties that are designed to produce high yields under a variety of environmental and adverse conditions. At the same time, the industry also seeks to decrease the costs and potential risks associated with traditional approaches such as fertilizers, herbicides and pesticides. In order to meet these demands, plant breeding techniques have been developed and used to produce plants with desirable phenotypes. Such phenotypes may include, for example, increased crop quality and yield, increased crop tolerance to environmental conditions (e.g., drought, extreme temperatures), increased crop tolerance to viruses, fungi, bacteria, and pests, increased crop tolerance to herbicides, and altering the composition of the resulting crop (e.g., increased sugar, starch, protein, or oil).

To breed plants which exhibit a desirable phenotype, a wide variety of techniques (e.g., cross-breeding, hybridization, recombinant DNA technology) can be employed. A crucial step in any of these methodologies is the assessment of phenotypes and traits in new plant varieties. Although strategies have been developed to reduce the time and expense required for making such assessments, significant time and cost are still necessary to evaluate crops under different stresses, seasons and environmental conditions. As a result, much effort has been made to increase throughput, lower cost and increase the accuracy and precision of evaluating new plant breeds.

One approach is to determine the degree to which a phenotype or trait is altered in an experimental or altered plant. In this manner, plants that exhibit the largest degree of change in a beneficial phenotype or trait can be selected for production or further development. By accurately selecting those plants that exhibit the most desirable properties, the agricultural industry can save both the time and cost associated with the development of new plant species that do not exhibit the most advantageous characteristics. Therefore, quantitative methods to determine the level of perturbation of a phenotype or a trait in plants would be extremely beneficial in the art.

### SUMMARY

Methods are provided for determining the level of perturbation of a phenotype or trait of interest in an organism. The organisms encompassed by the methods include, but are not limited to, plants, mammals, insects, fungi, viruses and bacteria. In one embodiment, the method comprises a first step of collecting at least one measurement from at least one control group of organisms and at least one experimental group of organisms to produce a set of data.

The method further comprises using a processor to conduct a multivariate statistical analysis of the set of data in order to determine the level of perturbation of the phenotype of interest in the experimental group of organisms. In one embodiment, the statistical analysis comprises arranging the set of data into a matrix, expressing the matrix into a set of new basis functions and projecting the set of data onto the set of new basis functions to calculate a set of scores for each group of organisms. In some examples, such new basis functions are eigenvectors.

The statistical analysis of the method further comprises the steps of determining a score space by calculating a distance between the set of scores generated for the control group of organisms and the set of scores generated for the experimental group of organisms. The score space is then used to determine the level of perturbation of the phenotype or trait of interest in the experimental group of organisms relative to the control group of organisms. Methods are further provided for selecting organisms based on the distance in the score space between the control group of organisms and the experimental group of organisms.

The following embodiments are encompassed by the present invention:

1. A method for determining the level of perturbation of a phenotype of interest in an organism, said method comprising:
(a) collecting at least one measurement from at least one control group of organisms and at least one experimental group of organisms to produce a set of data; and
(b) using a processor to conduct a multivariate statistical analysis on said set of data to determine said level of perturbation of said phenotype of interest in said at least one experimental group of organisms relative to said at least one control group of organisms.

2. The method of embodiment 1, wherein said collecting at least one measurement is performed using an analytical method.

3. The method of embodiment 2, wherein said analytical method comprises spectral analysis, gas chromatography-mass spectrometry analysis, liquid chromatography-mass spectrometry analysis, direct infusion mass spectrometry analysis, or any combination thereof.

4. The method of any one of the preceding embodiments, wherein said multivariate statistical analysis comprises:
(a) arranging said set of data into a matrix;
(b) expressing said matrix into a set of new basis functions;
(c) projecting said set of data onto said set of new basis functions to calculate a set of scores for said at least one control group of organisms and said at least one experimental group of organisms;
(d) determining a score space by calculating a distance between said set of scores of said at least one control group of organisms and said set of scores of said at least one experimental group of organisms; and,
(e) using said score space to determine said level of perturbation of said phenotype of interest in said at least one experimental group of organisms.

5. The method of embodiment 4, wherein said expressing said matrix into a set of new basis functions comprises using principle component analysis, partial least squares discriminant analysis, support vector machines, or any combination thereof.

6. The method of embodiment 4 or embodiment 5, wherein a larger distance in said score space is indicative of a larger perturbation of said phenotype of interest in said at least one experimental group of organisms, and wherein a smaller distance in said score space is indicative of a smaller perturbation of said phenotype of interest in said at least one experimental group of organisms.

7. The method of embodiment 6, further comprising the step of selecting said organisms based on said distance of said score space.

8. The method of any one of the preceding embodiments, wherein said at least one experimental group of organisms expresses at least one transgene.

9. The method of any one of the preceding embodiments, wherein said organism is a plant, a mammal, an insect, a fungus, a virus or a bacterium.

10. The method of embodiment 9, wherein said plant is a monocot or a dicot.

11. The method of embodiment 10, wherein said plant is maize, wheat, barley, sorghum, rye, rice, millet, soybean, alfalfa, Brassica, cotton, sunflower, potato, sugarcane, tobacco, Arabidopsis or tomato.

### BRIEF DESCRIPTION OF THE DRAWINGS

FIG. 1 sets forth modeling of the metabolic changes produced by drought stress across a range of genotypes and environments.

FIG. 2 sets forth the predicted class of transgene events that were statistically separated from null-segregants in the direction predicted using the well-watered metabolome.

FIG. 3 is a plot of the cross validation predictions of the perturbation in the plants produced by different events and constructs for a transgene. A single construct with many events is contrasted with the wild type. Discrimination analysis indicates clearly modeled changes in the plants' hyperspectral images for the transgenic plants compared to the wild type plants.

FIG. 4 is a plot of the cross validation predictions of the perturbation in different genotypes produced by a single transgenic event. Discrimination analysis indicates clearly modeled changes in the plants' hyperspectral images from the transgenic event.

FIG. 5 is a plot of attempted cross validation for a second genotype. Separation between the wild-type and transgenic classes is not possible based on the hyperspectral images of the plants.

FIG. 6 is a bar chart of the distance between two classes modeled with synthetic metabolomic data. Each model going to the right is built with data generated with increasing noise. As the signal to noise ratio decreases, the separation between the classes diminishes in the PLSDA score space.

### DETAILED DESCRIPTION

The present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements.

Many modifications and other embodiments of the invention set forth herein will come to mind to one skilled in the art to which this invention pertains having the benefit of the teachings presented in the foregoing descriptions and the associated drawings. Although specific terms are employed herein, they are used in a generic and descriptive sense only and not for purposes of limitation.

A crucial step in the development of new plant varieties is the assessment of their phenotypes and traits. Although methods have been developed to improve such assessments, significant time and cost are still necessary to determine which plants exhibit the most desirable characteristics under different environmental conditions. Accordingly, methods are provided for determining the level of perturbation of a phenotype in an organism. Such methods find use in the accurate identification of those organisms having particularly advantageous phenotypes and traits.

The organisms encompassed by the methods include, but are not limited to, plants, mammals, insects, fungi, viruses, and bacteria. In one example, the method comprises a first step of collecting at least one measurement from at least one control group of organisms and at least one experimental group of organisms to produce a set of data. The collection of such measurements can be performed by an analytical method, as described elsewhere herein.

The method further comprises a second step of using a processor to conduct a multivariate statistical analysis to determine the level of perturbation of a phenotype or trait of interest in the experimental group of organisms. The method can further comprise a step of providing an output of the multivariate statistical analysis to a user.

In one example, the multivariate statistical analysis comprises arranging the set of data into a matrix, expressing the matrix into a set of new basis functions, and projecting the set of data onto the set of new basis functions to calculate a set of scores for each of said at least two groups of organisms. In particular examples, principle component analysis (PCA), partial least squares discriminant analysis (PLSDA), support vector machines, or any combination thereof, are used to re-express the matrix. In other examples, the set of new basis functions produced by the method are eigenvectors.

The multivariate statistical analysis further comprises the steps of determining a score space by calculating a distance between the set of scores generated for the control group of organisms and the set of scores generated for the experimental group of organisms, and using the score space to determine the level of perturbation of the phenotype of interest in the experimental organisms relative to the control group of organisms. A larger distance in the score space is indicative of a larger perturbation of the phenotype or trait of interest in the experimental group of organisms relative to the control group of organisms. Accordingly, a smaller distance in the score space is indicative of a smaller perturbation of the phenotype or trait of interest in the experimental group of organisms.

Methods are further provided for selecting organisms based on the distance in the score space between the control group of organisms and the experimental group of organisms.

The methods encompass a multivariate statistical analysis of a set of data collected from at least one control group of organisms and at least one experimental group of organisms.

As used herein, a “control group of organisms” is one or more organisms that provide a reference point for measuring changes in a phenotype of interest in an experimental group of organisms. A control group of organisms may comprise, for example: (a) one or more wild-type organisms, i.e., of the same genotype as the starting material for the genetic alteration which resulted in the experimental organism; (b) one or more organisms of the same genotype as the starting material but which has been transformed with, or bred to comprise, a null construct (i.e. with a construct which has no known effect on the phenotype of interest, such as a construct comprising a marker gene); (c) one or more organisms that are non-transformed segregants among progeny of an experimental organism; (d) one or more organisms that are genetically identical to the experimental organisms but which are not exposed to conditions or stimuli that would induce expression of a phenotype of interest; or (e) the experimental organism itself under conditions in which the phenotype of interest is not expressed (e.g., altered environmental conditions, chemical treatment and the like).

A “genetic alteration” as described above can include both transgenic and non-transgenic means of genetically altering an organism. Genetic alterations can include the introduction of genetic material by recombinant DNA techniques. Alternatively, genetic alterations may result from classical breeding, crossing, introgression, mutagenesis, or hybridization techniques.

As used herein, an “experimental group of organisms” is a group of one or more organisms that have been treated or altered by some means, such that the organism(s) exhibit a phenotype of interest that is different as compared to the same phenotype of interest in a control group of organisms. Where the organism of the method is a plant, experimental plants may be treated or altered, for example, to regulate stress tolerance, pest tolerance, disease tolerance, chemical or herbicide resistance, crop yield or crop quality.

Methods for altering the organisms include, but are not limited to, any of the standard genetic engineering or breeding techniques that are used in the art to alter a phenotype or trait of an organism. Experimental organisms may be altered by one or more recombinant DNA techniques (e.g., transformation) to affect a gene that regulates a phenotype or trait of interest. In particular examples where the organism is a plant, genetic modification can be accomplished using one or more recombinant DNA techniques that are known in the art. Transformation protocols, as well as protocols for introducing polypeptides or polynucleotide sequences into plants, can be utilized to introduce recombinant DNA constructs, polypeptides or polynucleotides into a plant or plant cell for the purpose of altering a phenotype or trait of interest. Such recombinant DNA constructs may encode polypeptides or polynucleotides that, when expressed, regulate the expression of one or more genes in the plant that contribute to a phenotype or trait of interest.

Where the experimental organisms are plants, such plants may be altered by traditional plant breeding techniques, such as hybridization, cross-breeding, back-crossing and other techniques known to those of ordinary skill in the art in order to generate experimental plants that exhibit an altered phenotype or trait.

In particular examples, the organisms encompassed by the method include plants, mammals, insects, fungi, viruses and bacteria.

The term “plant” includes plant cells, plant protoplasts, plant cell tissue cultures from which plants can be regenerated, plant calli, plant clumps, and plant cells that are intact in plants or parts of plants such as embryos, pollen, ovules, seeds, leaves, flowers, branches, fruit, kernels, ears, cobs, husks, stalks, roots, root tips, anthers, and the like. Progeny, variants, and mutants of the plants are also included.

Plants that can be utilized include, but are not limited to, monocots and dicots. Examples of plant species of interest include, but are not limited to, corn (Zea mays), Brassica sp. (e.g., B. napus, B. rapa, B. juncea), alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), barley (Hordeum vulgare), oats (Avena sativa), sunflower (Helianthus annuus), safflower (Carthamus tinctorius), wheat (Triticum aestivum), soybean (Glycine max, Glycine soja), tobacco (Nicotiana tabacum, Nicotiana rustica, Nicotiana benthamiana), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentals), macadamia (Macadamia integrifolia), almond (Prunus amygdalus), sugar beets (Beta vulgaris), sugarcane (Saccharum spp.), vegetables, ornamentals, and conifers.

Vegetables of interest include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum.

Conifers of interest include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Hardwood trees can also be employed including ash, aspen, beech, basswood, birch, black cherry, black walnut, buckeye, American chestnut, cottonwood, dogwood, elm, hackberry, hickory, holly, locust, magnolia, maple, oak, poplar, red alder, redbud, royal paulownia, sassafras, sweetgum, sycamore, tupelo, willow, yellow-poplar.

In specific examples, plants of interest are crop plants (for example, corn, alfalfa, sunflower, Brassica, soybean, cotton, safflower, peanut, sorghum, wheat, millet, tobacco, etc.). In some examples, corn and soybean and sugarcane plants are of interest. Other plants of interest include grain plants that provide seeds of interest, oil-seed plants, and leguminous plants. Seeds of interest include grain seeds, such as corn, wheat, barley, rice, sorghum, rye, etc. Oil-seed plants include cotton, soybean, safflower, sunflower, Brassica, maize, alfalfa, palm, coconut, etc. Leguminous plants include beans and peas. Beans include guar, locust bean, fenugreek, soybean, garden beans, cowpea, mungbean, lima bean, fava bean, lentils, chickpea, etc.

Other plants of interest including Turfgrasses such as, for example, turfgrasses from the genus Poa, Agrostis, Festuca, Lolium, and Zoysia. Additional turfgrasses can come from the subfamily Panicoideae. Turfgrasses can further include, but are not limited to, Blue gramma (Bouteloua gracilis (H.B.K.) Lag. Ex Griffiths); Buffalograss (Buchloe dactyloids (Nutt.) Engelm.); Slender creeping red fescue (Festuca rubra ssp. Litoralis); Red fescue (Festuca rubra); Colonial bentgrass (Agrostis tenuis Sibth.); Creeping bentgrass (Agrostis palustris Huds.); Fairway wheatgrass (Agropyron cristatum (L.) Gaertn.); Hard fescue (Festuca longifolia Thuill.); Kentucky bluegrass (Poa pratensis L.); Perennial ryegrass (Lolium perenne L.); Rough bluegrass (Poa trivialis L.); Sideoats grama (Bouteloua curtipendula Michx. Torr.); Smooth bromegrass (Bromus inermis Leyss.); Tall fescue (Festuca arundinacea Schreb.); Annual bluegrass (Poa annua L.); Annual ryegrass (Lolium multiflorum Lam.); Redtop (Agrostis alba L.); Japanese lawn grass (Zoysia japonica); bermudagrass (Cynodon dactylon; Cynodon spp. L. C. Rich; Cynodon transvaalensis); Seashore paspalum (Paspalum vaginatum Swartz); Zoysiagrass (Zoysia spp. Willd; Zoysia japonica and Z. matrella var. matrella); Bahiagrass (Paspalum notatum Flugge); Carpetgrass (Axonopus affinis Chase); Centipedegrass (Eremochloa ophiuroides Munro Hack.); Kikuyugrass (Pennisetum clandesinum Hochst Ex Chiov); Browntop bent (Agrostis tenuis also known as A. capillaris); Velvet bent (Agrostis canina); Perennial ryegrass (Lolium perenne); and, St. Augustinegrass (Stenotaphrum secundatum Walt. Kuntze). Additional grasses of interest include switchgrass (Panicum virgatum).

The methods find use in measuring the perturbation of a phenotype of interest between groups of organisms. In this manner, the method can also be used to measure the perturbation of a trait of interest between groups of organisms, wherein the trait contributes to a phenotype of interest.

As used herein, a “phenotype of interest” is defined as a measurable characteristic of an organism. The phenotypes of interest encompassed can result from an alteration in one or more traits of interest in the organism that contribute to the phenotype. The term “trait of interest” is intended to mean the measurable characteristics of an organism that contribute to a particular phenotype of interest.

Where the organism of the method is a plant, phenotypes of interest include, but are not limited to, plant architecture, plant morphology, plant health, leaf texture phenotype, plant growth, total plant area, biomass, standability, dry shoot weight, yield, yield drag, physical grain quality, nitrogen utilization efficiency, water use efficiency, pest resistance, disease resistance, transgene effects, response to chemical treatment, abiotic stress tolerance, biotic stress tolerance, energy conversion efficiency, photosynthetic capacity, harvest index, source/sink partitioning, carbon/nitrogen partitioning, cold tolerance, freezing tolerance and heat tolerance.

Where the organism is a plant, traits of interest that contribute to a phenotype of interest include, but are not limited to, gas exchange parameters, days to silk (GDUSLK), days to pollen shed (GDUSHD), germination rate, relative maturity, lodging, ear height, flowering time, stress emergence rate, leaf senescence rate, canopy photosynthesis rate, silk emergence rate, anthesis to silking interval, percent recurrent parent, leaf angle, canopy width, leaf width, ear fill, scattergrain, root mass, stalk strength, seed moisture, seedling vigor, greensnap, shattering, visual pigment accumulation, kernels per ear, ears per plant, kernel size, kernel density, seed size, seed color, leaf blade length, leaf color, leaf rolling, leaf lesions, leaf temperature, leaf number, leaf area, leaf extension rate, midrib color, stalk diameter, leaf discolorations, number of internodes, internode length, kernel density, leaf nitrogen content, leaf shape, leaf serration, leaf petiole angle, plant growth habit, hypocotyl length, hypocotyl color, pubescence color, pod color, pods per plant, seeds per pod, flower color, silk color, cob color, plant height, chlorosis, albino, plant color, anthocyanin production, altered tassels, ears or roots, chlorophyll content, stay green, stalk lodging, brace roots, tillers, barrenness/prolificacy, glume length, glume width, glume color, glume shoulder, glume angle, head density, head color, head shape, head angle, head size, head length, panicle length, panicle width, panicle size, panicle shape, panicle color, panicle type, panicle branching, panicles per plant, culm angle, culm length, ligule color, ligule shape, spike shape, grain nitrogen content and plant or grain chemical composition (i.e., moisture, protein, oil, starch or fatty acid content, fatty acid composition, carbohydrate, sugar or amino acid content, amino acid composition and the like).

The methods encompass the collecting of at least one measurement from at least one control group of organisms and at least one experimental group of organisms to generate a set of data that can be used in a subsequent multivariate statistical analysis. A “set of data” means a collection of measurements, observations or readings obtained by any method of analysis used. As used herein, to “detect a change” means to identify or measure a quantitative or qualitative difference in a phenotype or trait of interest in an experimental group of organisms when compared to one or more control groups of organisms.

The analysis of the method can be accomplished using any analytical method capable of detecting a change in a phenotype or trait of interest. In particular examples, the analytical methods used include but are not limited to spectral analysis, gas chromatography-mass spectrometry (GC-MS) analysis, liquid chromatography-mass spectrometry (LC-MS) analysis, or direct infusion mass spectrometry (DI-MS) analysis.

As used herein, “spectral analysis” means a method for characterizing a phenotype of interest in an organism using spectral, multispectral or hyperspectral methods. Any method for collecting such measurements is encompassed, including manual methods and automated methods.

As used herein, the terms “mass spectrometry” or “MS” generally refer to methods of filtering, detecting and measuring ions based on their mass-to-charge ratio, or “m/z.” In MS techniques, one or more molecules of interest are ionized, and the ions are subsequently introduced into a mass spectrographic instrument (i.e., a mass spectrometer) where, due to a combination of magnetic and electric fields, the ions follow a path in space that is dependent upon their mass (“m”) and charge (“z”). See, e.g., U.S. Pat. No. 6,107,623, entitled “Methods and Apparatus for Tandem Mass Spectrometry,” which is hereby incorporated by reference in its entirety.

In particular examples, mass spectrometry is used along with with a chromatographic method to separate analytes prior to MS analysis. As used herein, a “chromatographic method” employs an “analytical column” or a “chromatography column” having sufficient chromatographic plates to effect a separation of the components of a test sample matrix. In some examples, the components eluted from an analytical column are separated in such a way to allow the presence and/or amount of an analyte(s) of interest to be determined. As used herein, “gas chromatography-mass spectrometry” or “GC-MS” first utilizes a gas chromatograph (GC) and a GC column that can sufficiently resolve analytes of interest and allow for their detection and/or quantification by MS analysis. Alternatively, the method may utilize “liquid chromatography-mass spectrometry” or “LC-MS”, wherein a high performance liquid chromatography (HPLC) column is utilized to resolve analytes of interest for detection by MS analysis. The method may further utilize “direct infusion mass spectrometry” or “DI-MS”, wherein a sample does not undergo separation prior to analysis by mass spectrometry.

The methods encompass the use of a processor to conduct a multivariate statistical analysis in order to determine the level of perturbation of a phenotype or trait of interest in at least one experimental group of organisms.

As used herein, a “multivariate statistical analysis” is intended to mean the use of any one of a number of statistical analyses that are known in the art for analyzing data arising from more than one variable. Such techniques find use in determining the level of perturbation of a phenotype or trait of interest between two or more groups. “Level of perturbation” is defined as the degree to which a phenotype or trait is altered in an organism when compared to a control organism or a control group of organisms.

In one example, the multivariate statistical analysis comprises the steps of arranging the set of data into a matrix, expressing the matrix as a set of new basis functions and projecting the set of data onto the set of new basis functions to calculate a set of scores for each of the groups of organisms.

Standard methods for arranging a set of data into a matrix are well known to those of ordinary skill in the art, as are methods for optimizing a matrix for use in a specific algorithm. As used herein, “expressing” a matrix means the use of any mathematical method that renders one or more matrices into a set of new basis functions. Methods for expressing matrices as a set of new basis functions are well known in the art and include LU decomposition, Gaussian elimination, singular value decomposition, eigendecomposition, Jordan decomposition and Schur decomposition. As used herein, a “set of new basis functions” means a set of linearly independent vectors that, in a linear combination, can represent every vector in a given vector space or free module, or, alternatively, define a “coordinate system.” The set of new basis functions produced by the method can, in some examples, be a set of eigenvectors. “Eigenvectors” are well known in the art and can be defined as the non-zero vectors of a matrix which, after being multiplied by the matrix, remain proportional to the original vector.

In particular examples, principle component analysis (PCA), partial least squares discriminant analysis (PLSDA), support vector machines, or any combination thereof, are used to express the matrix as a set of new basis functions. Methods of expressing one or more matrices as a set of new basis functions using PCA, PLSDA, support vector machines, or a combination thereof, are known to those of ordinary skill in the art. As used herein, “principle component analysis” or “PCA” means any mathematical procedure that uses an orthogonal transformation to convert a set of observations of possibly correlated variables into a set of values of uncorrelated variables called principal components. By “partial least squares discriminant analysis” or “PLSDA” is meant the use of statistical analyses that discriminate between two or more groups. PLSDA is also known to those of ordinary skill in the art and may be utilized in certain examples where qualitative predictions might be expected. As used herein, “support vector machines” describe statistical analyses that are classifier algorithms which determine a boundary (i.e., an n-dimensional hyperplane) which distinguishes between class members.

The set of data obtained by the method is then projected or measured for onto the set of new basis functions in order to calculate a set of scores for the control group of organisms and a set of scores for the experimental group of organisms. As used herein, to “calculate a set of scores” means to transform the original data set into the set of new basis functions. The scores are the weights in the new basis functions and are equivalent to the original data. The scores are optimized to more readily interpret for selection or classification of a trait or phenotype.

When scores have been calculated for the control group of organisms and the experimental group of organisms, a score space is determined by the method. As used herein, a “score space” defines where the distance between the scores generated for each group of organisms is calculated. A larger distance in the score space is indicative of a larger perturbation of the phenotype or trait of interest in the experimental group of organisms. Accordingly, a smaller distance in the score space is indicative of a smaller perturbation of the phenotype or trait of interest in the experimental group of organisms. In one example, score space values that can be used for quantitative selection of an experimental group of organisms range from about 0.3-5.0, from about 0.3-1.0, or from about 0.3-0.5.

Methods are further provided for selecting a group of organisms based on the distance in the score space between the control group of organisms and the experimental group of organisms. In a particular example, an experimental group of organisms may be selected quantitatively, wherein the score of one group is determined to be greater than the score of another group. In this manner, the degree of perturbation of a phenotype or trait of interest would be greater in the selected group of organisms. In another example, a group of organisms may be selected qualitatively when the score space between the experimental group and the control group is greater than a pre-defined value.

As used herein, a “processor” provides a means to conduct the multivariate statistical analysis of the method. The processor of the method can also provide an output of the method to a user, such that the output comprises the result(s) of the multivariate statistical analysis of the method.

The processor of the method may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor may be configured to execute instructions stored in a memory device or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal or network device) adapted for employing an embodiment of the present invention by further configuration of the processor by instructions for performing the algorithms and/or operations described herein. The processor may include, among other things, a clock, an arithmetic logic unit (ALU) and logic gates configured to support operation of the processor.

As used herein, the term “circuitry” refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

The article “a” and “an” are used herein to refer to one or more than one (i.e., to at least one) of the grammatical object of the article. By way of example, “an element” means one or more element.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims.

### EXAMPLES

### Example 1

### Qualitative Class Prediction For Ranking Transgenes in Response to Drought

A PLSDA classification model was built between unmodified stressed and unstressed plants that weight each metabolite according to its ability to separate the treatments. The model was then used to predict the modified plants' response to stress according to the methods. The score space in this case was defined by metabolomic data derived from the stressed and unstressed plants. Proximity to the unstressed class while undergoing stress treatment was used for selection of a favorable genotype.

### Gas Chromatograph and Time of Flight Mass Spectrometer Settings and Methods

Metabolites were extracted from three lyophilized leaf discs of approximately 3 mg combined dry weight. Five hundred microliters of a chloroform:methanol:water solution (2:5:2, v/v/v) containing 0.015 mg ribitol internal standard were added to each sample in a 1.1 mL polypropylene microtube containing two 5/32″ stainless steel ball bearings. Samples were homogenized in a 2000 Geno/Grinder ball mill at setting 1,650 for 1 min. and then rotated at 4° C. for 30 min. Samples were then centrifuged at 1,454×g for 15 min, 4° C. Next, 300 μL aliquots were transferred to 1.8 mL high recovery GC vials and subsequently evaporated to dryness in a speed vac. The dried residues were re-dissolved in 50 μL of 20 mg/mL methoxyamine hydrochloride in pyridine, capped, and agitated with a vortex mixer. The samples were incubated in an orbital shaker at 30° C. for 90 min to form methoxyamine derivatives. Eighty microliters N-methyl-N-(trimethylsilyl)trifluoroacetamide (MSTFA) were added to each sample to form trimethylsilyl derivatives. The MSTFA delivery to individual samples was performed by the gas chromatograph autosampler 30 min prior to injection, minimizing greatly among sample variability due to differences in the state of derivatization.

Trimethylsilyl derivatives were separated by gas chromatography on a Restek 30 m×0.25 mm id×0.25 p.m film thickness Rtx®-5Sil MS column with 10 m integra guard column. One microliter injections were made with a 1:10 split ratio using a CTC Combi PAL autosampler. The Agilent 6890N gas chromatograph was programmed for an initial temperature of 80° C. for 5 min, increased to 350° C. at 18°/min where it was held for 2 min before being cooled rapidly to 80° C. in preparation for the next run. The injector and transfer line temperatures were 230° C. and 250° C., respectively, and the source temperature was 200° C. Helium was used as the carrier gas with a constant flow rate of 1 mL/min maintained by electronic pressure control. Data acquisition was performed on a LECO Pegasus III time-of-flight mass spectrometer with an acquisition rate of 10 spectra/sec in the mass range of m/z 45-600. An electron beam of 70eV was used to generate spectra. Detector voltage was approximately 1550-1800 V depending on the detector age. An instrument auto tune for mass calibration using PFTBA (perfluorotributylamine) was performed prior to each GC sequence.

### Preprocessing raw GC/ToFMS

Genedata Expressionist Refiner was used to assemble and align the sample gas chromatograph coupled with a time of flight mass spectrometer data with feature selection and noise reduction. The first step was to generate and fit all of the data to a common time grid. Noise reduction was then performed using smoothing, statistical analysis and thresholding. The retention times were then aligned using a correlation based alignment function. The first chromatogram was used as a retention time alignment reference. The output of this workflow was a table of intensities associated with retention times and charge to mass ratios representing a molecular fragment from the electron impact collected on the mass spectrometer.

The data was then loaded into the Matlab (MathWorks, Natick, Mass.) workspace for further processing. Starting with the latest retention time the correlation between all of the m/z data points within a retention time window of 0.5 seconds was determined. Within this retention time window a Pierson correlation coefficient matrix was calculated across all samples. The m/z channels were assembled into clusters using the K nearest neighbor agglomerative method. Clusters were made when the calculated neighboring distance was less than 1. A cluster further required more than five mass fragment channels to be included in the modeling data. If a mass fragment signal channel was not within the minimum distance of a five member cluster it was eliminated from the table of data. This process was repeated until all data channels were clustered or eliminated on a single basis. Once all of the correlated clusters within a retention time window had been calculated, the mass fragment channel with the highest frequency of being the maximum within each sample cluster was selected as the intensity for this cluster across all samples.

### Modeling

In modeling, all of the data was preprocessed by autoscaling, or by dividing each data channel by its standard deviation in the data set followed by mean centering. In each case, partial least squares (PLS) multivariate calibrations were built to predict a quantitative outcome from the metabolome. In the cases of where qualitative predictions were expected, these states were digitally represented as ones and zeros as a result of using PLSDA. In each case, cross validation or validation were used to select the number of latent variables. In no case did the number of latent variables exceed five and in most it was only two. Outliers were identified using principal component analysis and cross validation. All modeling was performed using the PLSToolbox from Eigenvector Research Inc. (Wenatchee, Wash.).

### Qualitative Class Prediction for Ranking Transgenes in Response to Drought

Two drought tolerant constructs and their controls were tested in a greenhouse drought assay with independent planting dates for each of the constructs. The seeds were from the first segregating ear of seed generated from transformation. Fifteen of each of the null and the positive segregants were grown with sufficient water (control treatment) and reduced water (experimental treatment) in a controlled environment. Metabolomic data was collected on plantlets as described above. The PLSDA was built across both projects for the treatment using just the control plants and the top 20 predictive weight ranking metabolite signals determined by the variable importance projection calculated from an all variable model.

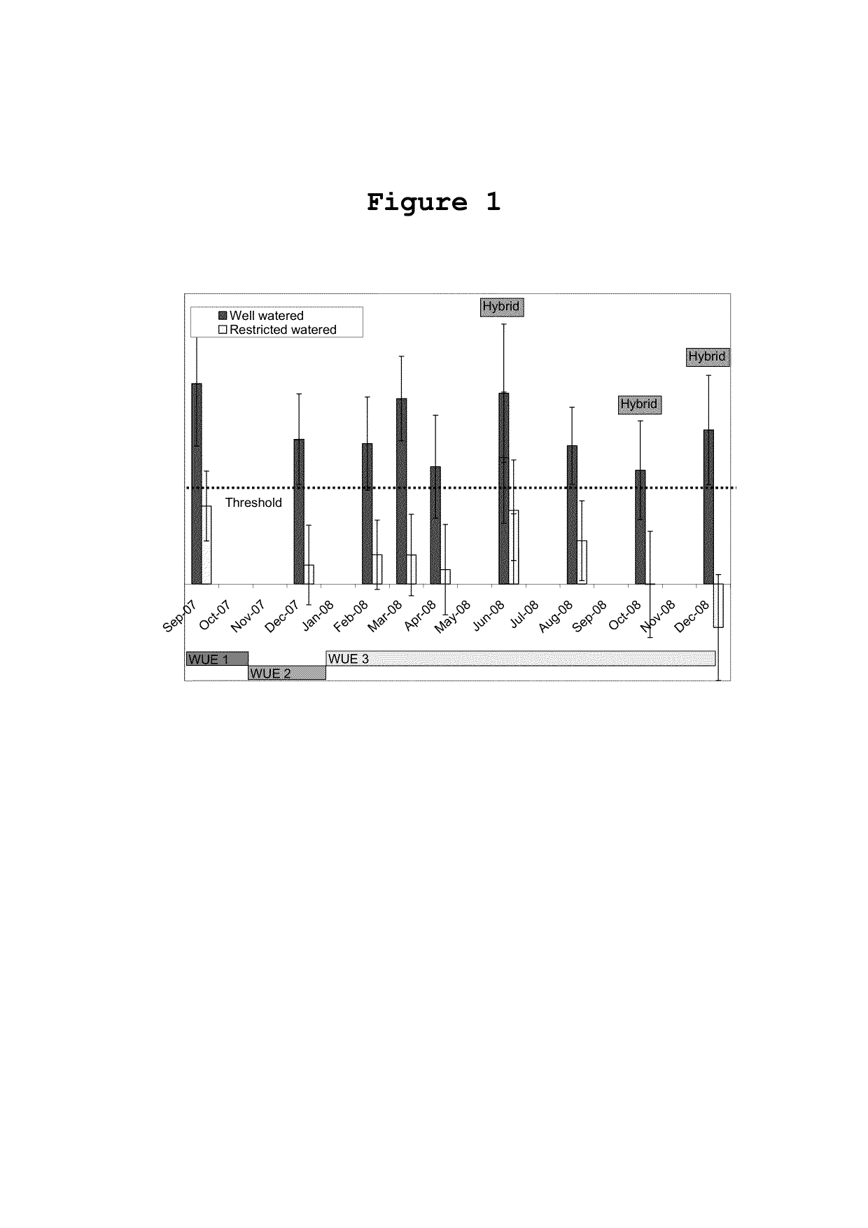

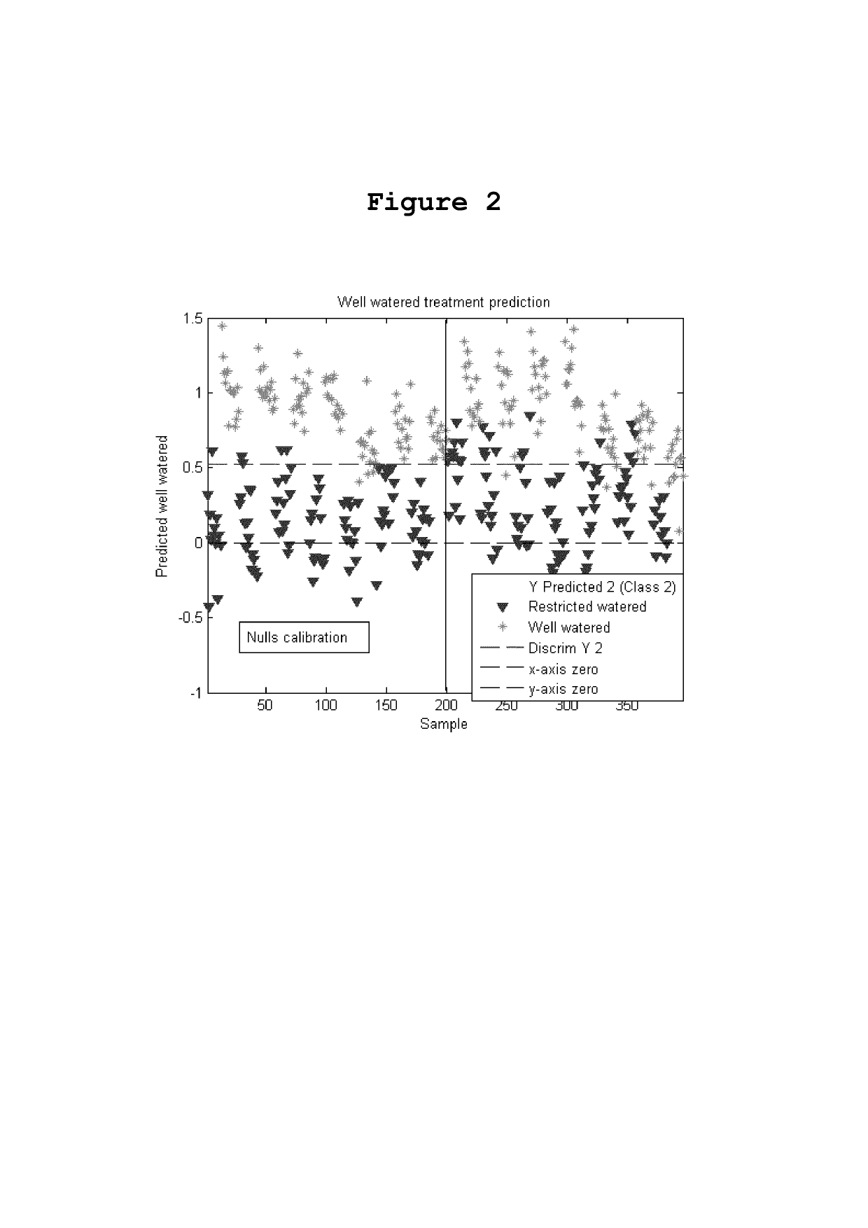

This model captures the metabolic changes produced by drought stress across a range of genotypes and environments as shown in FIG. 1. The model was then applied to the transgene positive segregants. For the drought-stressed transgene positive segregants, the predicted class of these transgene events was statistically separated from the null segregants in the direction predicted by the unstressed metabolome. In the prediction that follows in FIG. 2, the left half figure shows the predictions for the null segregants used to make the model. The right half of the figure contains the predictions of the positive segregants. The mean numerical represented class prediction for each of the seven events ranked with the PLSDA model are given in Table 1. Metabolomes significantly altered away from the drought stress metabolome are highlighted shown in bold & italicized font. The events that are bolded/italicized also had significantly different phenotypes including but not limited to increased plant biomass.

TABLE 1
The numerical-represented class predictions are given
for seven events shown graphically in FIG. 2.

| | Null | Event | Null | Std. Dev. | Std. Dev. | |
|---|---|---|---|---|---|---|
| Event | mean | mean | Event | Null | Event | P-value |
| 1 | 0.1366 | 0.0191 | 0.1175 | 0.2379 | 0.2393 | 5.49E−02 |
| [symbol] | [symbol] | [symbol] | [symbol] | [symbol] | [symbol] | [symbol] |
| 3 | 0.1366 | 0.2049 | −0.0683 | 0.2379 | 0.3022 | 1.61E−01 |
| 4 | 0.1366 | 0.0858 | 0.0508 | 0.2379 | 0.2218 | 2.27E−01 |
| [symbol] | [symbol] | [symbol] | [symbol] | [symbol] | [symbol] | [symbol] |
| [symbol] | [symbol] | [symbol] | [symbol] | [symbol] | [symbol] | [symbol] |
| [symbol] | [symbol] | [symbol] | [symbol] | [symbol] | [symbol] | [symbol] |

### Example 2

### Qualitative Prediction of Genotypes Response to Transgenes

In wide scale testing of transgenic corn hybrids, an unstable phenotype was observed in some genotypes. Twenty two hybrids with the trait were planted in Chile in a field experiment. Hybrids from the same genotype with different trait stacks were also included to provide metabolic contrasts. Based on the extensive product testing, hybrids were classified according to the observation of the phenotypic effects. The score space in this case is defined by the changes in the metabolome produced by the transgene(s) overlapped with expected yield performance of the genotypes. Distances relative to the perturbation and performance classes were calculated and used to select high yielding genotypes.

A PLSDA model was calculated using a single hybrid genotype with the trait incorporated into the hybrid from each of the parents. In the Chile experiment, one of these common parents' hybrids exhibited the negative phenotype, while the other did not. The other had a phenotype statistically equivalent to the based hybrid without traits. The classes in this PLSDA model were negative phenotypic effect and no effect. The model was improved through variable selection using a genetic algorithm (PLS Toolbox, Eigenvector Research, Wenatchee, Wash.) and the other hybrids as a validation set. Using the predictions from the replicates, a probability of unstable phenotype for each hybrid genotype was estimated from the distribution of predictions compared to the calibration hybrid predictions. Table 2 contains the metabolome-estimated probability of negative phenotype. Positive phenotypes observed in large scale testing are indicated with plus (+) signs. All of the observed negative phenotypes were predicted by the model. The bolded/italicized rows indicate an agreement between the predicted and observed phenotypes.

TABLE 2

| Hybrid | Probability of High Yield | Observed high yield |
|---|---|---|
| 1 | 0.997 | |
| [symbol] | [symbol] | + |
| [symbol] | [symbol] | + |
| [symbol] | [symbol] | + |
| 5 | 0.767 | + |
| 6 | 0.737 | + |
| 7 | 0.578 | |
| 8 | 0.538 | |
| 9 | 0.488 | + |
| 10 | 0.411 | + |
| 11 | 0.34 | |
| [symbol] | [symbol] | − |
| [symbol] | [symbol] | − |
| [symbol] | [symbol] | − |
| [symbol] | [symbol] | − |
| [symbol] | [symbol] | − |
| [symbol] | [symbol] | − |
| [symbol] | [symbol] | − |
| [symbol] | [symbol] | − |
| [symbol] | [symbol] | − |
| [symbol] | [symbol] | − |
| [symbol] | [symbol] | − |

### Example 3

### Prediction of Perturbation of Plants with Different Constructs and Events

A model was created to predict whether a maize plant would be expected to have an off-type phenotype when comprising transgenic constructs or events. The characteristic that was modeled and predicted was whether a maize plant perturbation results from the transgene. This model was used to predict the degree to which a common genotype was perturbed by different transgenic events and constructs. The modeling classifies plants into more classes. The score space was defined by the transgene produced changes in the plants' average reflectance spectra calculated from a hyperspectral image. Proximity in this space to the wild type was used for selection.

For the experiment, maize hybrids from the same base genetics comprising different constructs and different events for a transgene were planted and grown along with a control wild type genotype. Multi- or hyper-spectral data was collected for the plots by remote sensing imaging from which X-block calibration data can be extracted. Existing techniques were used to directly evaluate the genotypes and phenotypes of the plants and classify them as transgenic or wild type. The Y-block (classification in the PLSDA model) was the wild type and transgenic classes. An inverse modeling approach was used to develop a model using commercially available software (PLS Toolbox, Eigenvector Research).

In this example, PLSDA was used. The method produces a PLS-based calibration model, hut creates distinct classes using sample classes in the X-block calibration data. Other types of classification methods are known. Examples include, but are not limited to, SIMCA and k nearest neighbor.

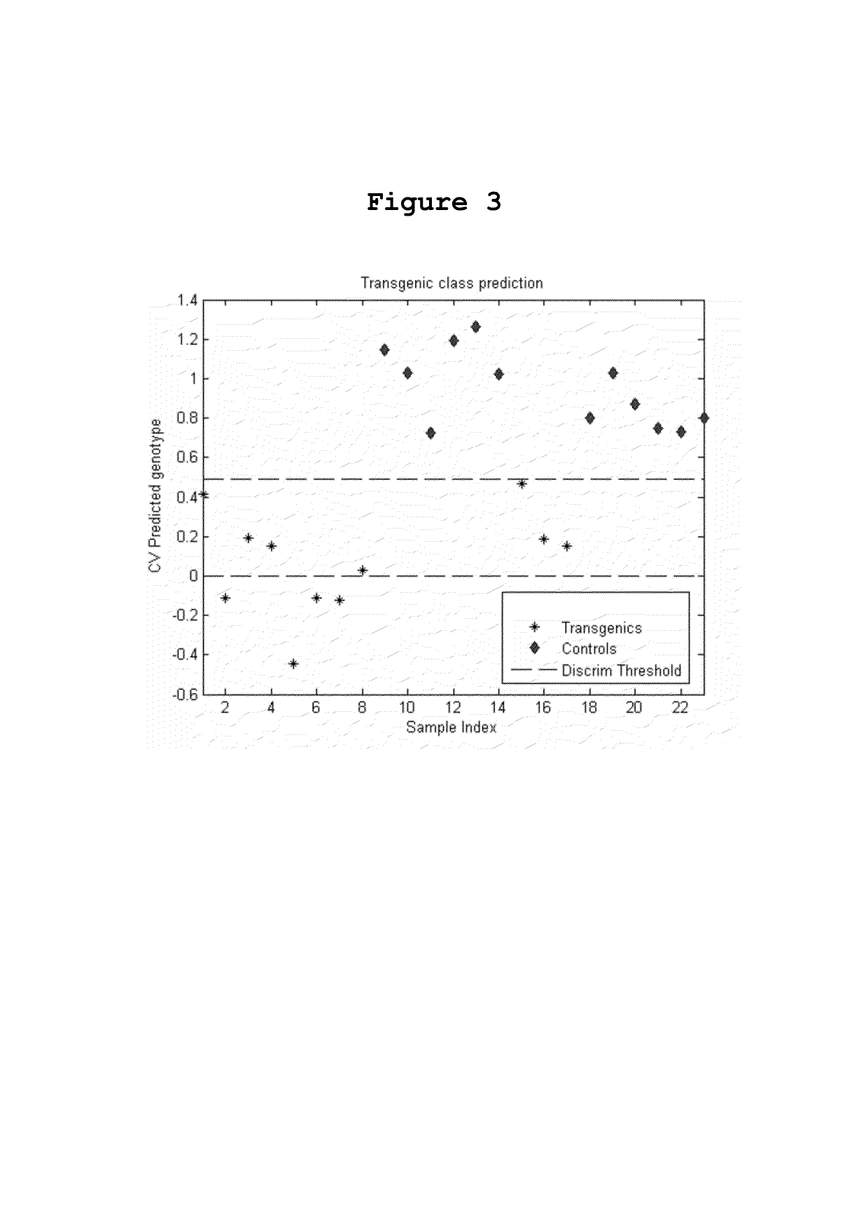

FIG. 3 shows a discriminant analysis plot based on the cross validation predictions showing a sample/score plot for a plurality of samples. In this case, the wild type plants were assigned a Y-block reference value of 1, while the transgenic plants were assigned a Y-block reference value of 0. The model minimizes the least squares error between the predicted classes and the assigned reference. The model-defined threshold was approximately 0.5. Predicted values above this line were expected at the 95% confidence level to be wild type. Below this threshold, the samples were predicted to be transgenic.

The black diamonds in FIG. 3 show good separation of scores from a set of samples indicating the perturbation by the transgene. Such perturbation may, in some examples, include an effect (negative) of the transgene insertion on the agronomics of the plant background. The perturbation may also mean that the transgene itself is perturbed, corrupted, or altered in the insertion event. The perturbation may also mean that expression of the transgene impacts the overall phenotype in this plant background. Perturbation also includes situations where the transgene results in a more effective or desirable plant outcome. The perturbation may also occur in a pre-transcription or post-transcription stage. The plot shows other samples symbols) that do not fall within this diamond class and are the control plants.

### Example 4

### Prediction of Perturbation of Plants from Multiple Genotypes with the Same Transgene

A model was created to predict whether a constituent or characteristic of a maize plant was perturbed by a transgene, thus affecting its hyperspectral image. The degree and direction of the perturbation defined the score space and could be used to select constructs and events in transgene analysis. The models built in this example were suitably used to predict the response of genotypes to a transgene. Perturbations in the hyperspectral image consistent with a desired transgenic phenotype were used to select genotypes for transformation.

For the experiment, maize inbreds with and without a trait transgene were grown in a controlled environment, Multi- or hyper-spectral data was collected for the plots by remote sensing imaging from which X-block calibration data could be extracted. Techniques known in the art were used to directly assign the genotype and phenotype. In this case, genotype and phenotype were assigned from data collected in field size strip-testing trials over wide ranges of environments and management practice. The Y-block reference values were wild type and transgenic.

An inverse modeling approach was used to develop a model using commercially available software. In this example, PLSDA was used as in Example 3 above.

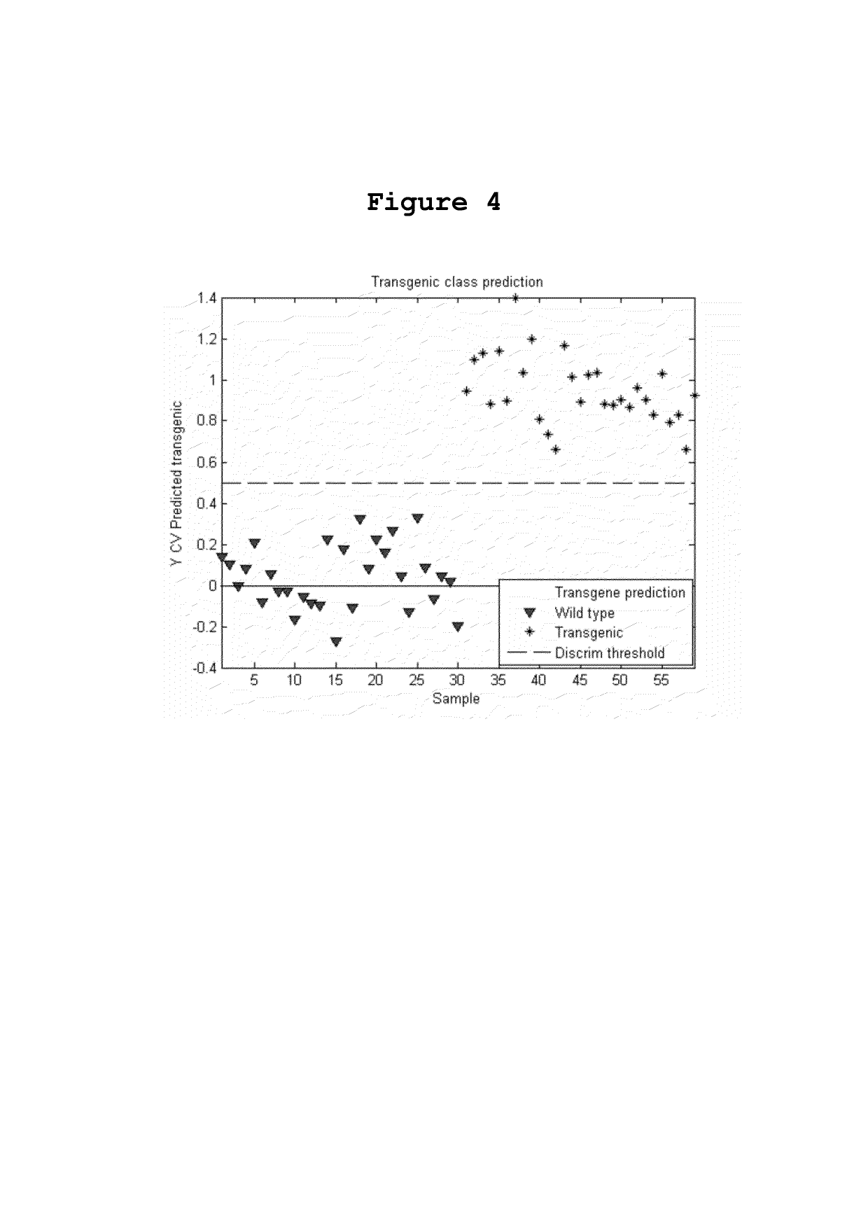

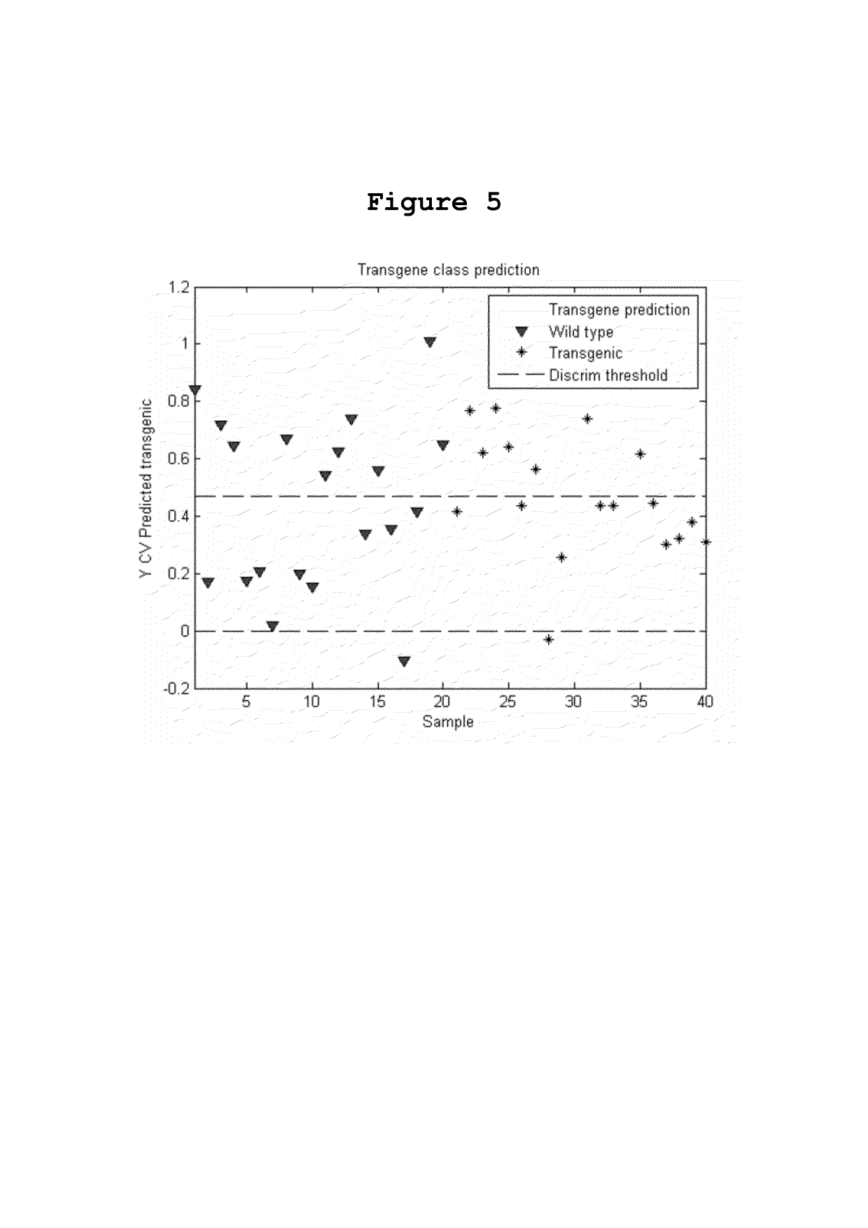

FIG. 4 shows a discriminant analysis plot based on the cross-validation predictions showing a sample/score plot for a plurality of samples. In this case the transgenic plants were assigned a Y-block reference value of 1, while the wild type plants were assigned a Y-block reference value of 0. The model minimizes the least squares error between the predicted classes and the assigned reference. The model-defined threshold was approximately 0.5. Predicted values above this line were expected at the 95% confidence level to be transgenic. Below this threshold the samples were predicted to be wild type. The transgenic data points (stars) show good separation of scores from a set of samples, indicating the perturbation of the transgene in one genotype. The plot shows other samples, triangles, that do not fall within this star class and, thus, are the control plants. FIG. 5 is for a different genotype where the perturbation to the hyperspectral image is not sufficient for discriminant analysis modeling.

### Example 5

### Adding Noise to Model Data to Reduce/Eliminate the Score Space Between Two Groups

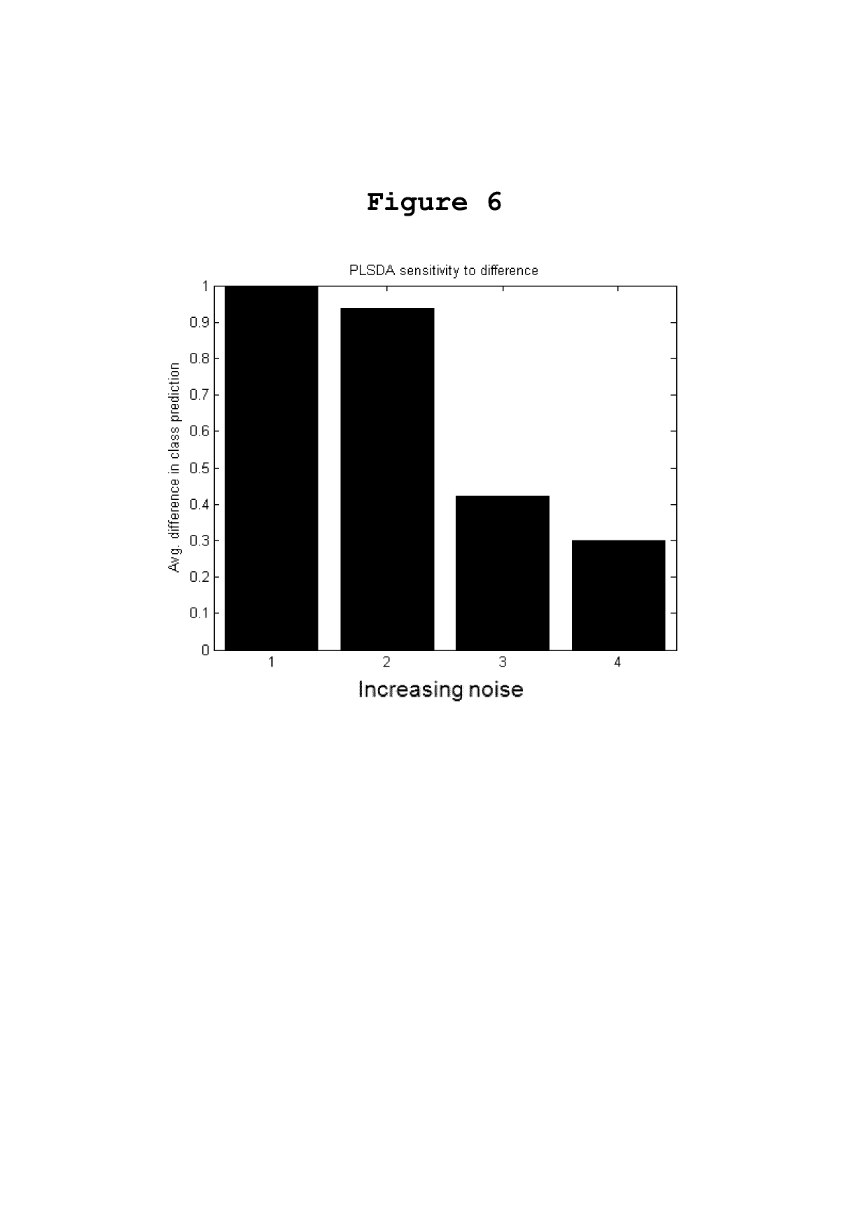

A model was calculated using a synthetic data set of metabolomic data. The first model was built for a set of 30 samples divided between two classes represented by different metabolomes. The metabolome was represented by seven variables. For each of the two classes there were two metabolome variables that could be used in univariate statistical analysis to separate the classes. As a synthetic set of data, there was no noise and so the PLSDA model was perfect in classification of the samples. Further the distance in the score space between the two classes was calculated to be exactly one. Increasing noise was added to the synthetic metabolome. As the noise increased (X-axis) the distance measured in the PLSDA space between the two classes steadily decreased (Y-axis) along with its statistical significance. FIG. 6 records the change in distance between the classes in score space as the noise is increased.

That which is claimed:

1. A method for determining the level of perturbation of a phenotype of interest in an organism, said method comprising:
(a) collecting at least one measurement from at least one control group of organisms and at least one experimental group of organisms to produce a set of data; and
(b) using a processor to conduct a multivariate statistical analysis on said set of data to determine said level of perturbation of said phenotype of interest in said at least one experimental group of organisms relative to said at least one control group of organisms.

2. The method of claim 1, wherein said collecting at least one measurement is performed using an analytical method.

3. The method of claim 2, wherein said analytical method comprises spectral analysis, gas chromatography-mass spectrometry analysis, liquid chromatography-mass spectrometry analysis, direct infusion mass spectrometry analysis, or any combination thereof.

4. The method of claim 1, wherein said multivariate statistical analysis comprises:
(a) arranging said set of data into a matrix;
(b) expressing said matrix into a set of new basis functions;
(c) projecting said set of data onto said set of new basis functions to calculate a set of scores for said at least one control group of organisms and said at least one experimental group of organisms;
(d) determining a score space by calculating a distance between said set of scores of said at least one control group of organisms and said set of scores of said at least one experimental group of organisms; and,
(e) using said score space to determine said level of perturbation of said phenotype of interest in said at least one experimental group of organisms.

5. The method of claim 4, wherein said expressing said matrix into a set of new basis functions comprises using principle component analysis, partial least squares discriminant analysis, support vector machines, or any combination thereof.

6. The method of claim 4, wherein a larger distance in said score space is indicative of a larger perturbation of said phenotype of interest in said at least one experimental group of organisms, and wherein a smaller distance in said score space is indicative of a smaller perturbation of said phenotype of interest in said at least one experimental group of organisms.

7. The method of claim 6, further comprising the step of selecting said organisms based on said distance of said score space.

8. The method of claim 1, wherein said at least one experimental group of organisms expresses at least one transgene.

9. The method of claim 1, wherein said organism is a plant, a mammal, an insect, a fungus, a virus or a bacterium.

10. The method of claim 9, wherein said plant is a monocot or a dicot.

11. The method of claim 10, wherein said plant is maize, wheat, barley, sorghum, rye, rice, millet, soybean, alfalfa, Brassica, cotton, sunflower, potato, sugarcane, tobacco, Arabidopsis or tomato.

12. A method for determining the level of perturbation of a phenotype of interest in a plant, said method comprising:
(a) collecting at least one measurement from at least one control group of plants and at least one experimental group of plants to produce a set of data, wherein said step of collecting is performed using an analytical method; and,
(b) using a processor to conduct a multivariate statistical analysis on said set of data to determine said level of perturbation of said phenotype of interest in said at least one experimental group of plants relative to said at least one control group of plants, wherein said multivariate statistical analysis comprises:
(i) arranging said set of data into a matrix;
(ii) expressing said matrix into a set of new basis functions, wherein said expressing is performed using principle component analysis, partial least squares discriminant analysis, or a combination thereof;
(iii) projecting said set of data onto said set of new basis functions to calculate a set of scores for said at least one control group of plants and said at least one experimental group of plants;
(iv) determining a score space by calculating a distance between said set of scores of said at least one control group of plants and said set of scores of said at least one experimental group of plants;
(v) using said score space to determine said level of perturbation of said phenotype of interest in said at least one experimental group of plants, wherein a larger distance in said score space is indicative of a larger perturbation of said phenotype of interest in said at least one experimental group of plants, and wherein a smaller distance in said score space is indicative of a smaller perturbation of said phenotype of interest in said at least one experimental group of plants; and
(vi) selecting said experimental group of plants based on said distance of said score space.
